(19) United States
(12) Patent Application Publication
(10) Pub. No.: US 2007/0092765 A1
(43) Pub. Date: Apr. 26, 2007

(54) Heater for fuel reforming reactor and fuel cell system using the same

(76) Inventors: Sang Jun Kong, Yongin-si (KR); Myeong Jun Ha, Yongin-si (KR); Dong Uk Lee, Yongin-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/584,232

(22) Filed: Oct. 20, 2006

(30) Foreign Application Priority Data
Oct. 21, 2005 (KR) 10-2005-0099919

(51) Int. Cl. C10L 1/12; H01M 8/00

(52) U.S. Cl. 429/13; 431/2

(57) ABSTRACT

Disclosed is a fuel reforming system, which includes a heater to combustion fuel that mainly contains butane gas and a reformer to receive heat energy from the heater. The reformer produces reformed gas that mainly contains hydrogen from reforming fuel that mainly contains butane gas. An igniter has an electrode inserted into the burner. The igniter ignites the fuel such as butane gas.

### CROSS-REFERENCE TO RELATED APPLICATIONS

This application claims the benefit of Korean Patent Application No. 10-2005-0099919, filed on Oct. 21, 2005, in the Korean Intellectual Property Office, which is incorporated herein by reference in its entirety.

### BACKGROUND

1. Field of the Invention

The present invention relates to a fuel cell system, and more particularly, to a heater for use in a fuel cell system.

2. Discussion of Related Art

In general, a fuel cell system generates electric energy through a chemical reaction between hydrogen and oxygen or between reformed gas containing abundant hydrogen and oxygen, in which the reformed gas is obtained from a hydrogen containing fuel that includes an alcoholic fuel such as methanol, ethanol, etc.; a hydro-carbonaceous fuel such as methane, propane, butane, etc.; or a natural gas fuel such as liquefied natural gas, etc. The fuel cell system has been researched and developed as an alternative to secure a power source corresponding to an increased demand of power and to solve environmental problems.

The fuel cell system is classified into a phosphoric acid fuel cell (PAFC), a molten carbon fuel cell (MCFC), a solid oxide fuel cell (SOFC), a polymer electrolyte membrane fuel cell (PEMFC), an alkaline fuel cell (AFC), etc. according to kinds of used electrolytes. Further, the fuel cell system can be applied to various fields such as a mobile device, transportation, a distributed power source, etc. according to kinds of fuel, a driving temperature, an output range, etc.

Meanwhile, as an example of such a fuel cell system, there has been disclosed a fuel cell system in Korean patent first publication No. 10-2000-0022545 (refer to FIG. 5). This fuel cell system includes a portable pressure container containing butane gas, a reformer using some butane gas contained in the pressure container as fuel gas and reacting the other some butane gas with water to produce reformed gas containing hydrogen gas, a fuel cell using hydrogen in the reformed gas and oxygen in air to generate electricity, a unit for adjusting the amount of butane gas, and a unit for controlling flux of the butane gas.

Further, there has been disclosed a reformer in Korean patent first publication No. 10-2000-0022546 (refer to FIG. 6), the reformer including a raw material reforming part that directly receives heat of reaction from a heat source so as to steam-reform the reforming fuel and thus produce reformed gas with a hydrogen base, together with a shift reaction part and a CO oxidation part, which are indirectly heated by electric heat from the heat source.

The discussion in this section is to provide general background information of the fuel cell technology, and does not constitute an admission of prior art.

### SUMMARY OF CERTAIN INVENTIVE ASPECTS

An aspect of the invention provides a method of heating a fuel reforming reactor for use with a fuel cell, which may comprise: providing a heater comprising a chamber, a nozzle and an igniter, wherein the nozzle comprises an opening formed into the chamber, wherein the igniter comprises an ignition tip located in the chamber; supplying a fuel into the chamber through the opening of the nozzle; igniting the fuel within the chamber using the ignition tip; oxidizing the fuel and thereby generating heat within the chamber; and supplying the heat to a fuel reforming reactor; wherein the temperature at the ignition tip is substantially different from the temperature at the opening of the nozzle substantially throughout during oxidizing the fuel.

In the foregoing method, the temperature of the ignition tip may be different from temperature at the opening of the nozzle by at least 10 to 200° C. The temperature of the ignition tip may be different from temperature at the opening of the nozzle by at least 50 to 100° C. The temperature of the ignition tip may be substantially lower than the temperature at the opening of the nozzle. The temperature of the ignition tip may be substantially lower than the temperature at the opening of the nozzle by at least 10 to 200° C. The nozzle may be configured to inject fuel into the chamber in a direction, wherein the chamber may have a length in the direction, and wherein the ignition tip may be located at a position, which is distanced from the opening with a distance more than about one tenth of the length in the direction. The nozzle may be configured to inject fuel into the chamber in a first direction, wherein the chamber may have a length in a second direction perpendicular to the first direction, and wherein the ignition tip may be located at a position, which is distanced from the opening with a distance more than about one tenth of the length in the second direction. The ignition tip is located in an area where the temperature thereof does not reach 1000° C.

Still in the foregoing method, the ignition tip may comprise a carbon electrode, and wherein the fuel may comprise butane. The fuel may comprise at least one compound selected from the group consisting of methane, ethane, propane, butane, pentane, hexane, heptane, octane, ethylene, propylene, butylene, and acetylene. The heater may further comprise a wall substantially creating a temperature barrier between the opening and the ignition tip. Igniting may create a flame within the chamber, wherein the flame may not contact the ignition tip. The heater may further comprise an oxidation catalyst in the chamber.

Another aspect of the invention provides an apparatus for use in heating a fuel reforming reactor of a fuel cell, which may comprise: an oxidation chamber; a nozzle configured to supply fuel into the oxidation chamber, the nozzle comprising an opening formed into the chamber; and an igniter comprising an ignition tip configured to ignite fuel within the chamber, wherein the ignition tip is distanced from the opening such that wherein the temperature at the ignition tip is substantially different from the temperature at the opening of the nozzle substantially throughout during oxidizing the fuel.

The nozzle may be configured to inject fuel into the chamber in a direction, wherein the chamber may have a length in the direction, and wherein the ignition tip may be located at a position, which is distanced from the opening with a distance more than about one tenth of the length in the direction. The nozzle may be configured to inject fuel into the chamber in a first direction, wherein the chamber may have a length in a second direction perpendicular to the first direction, and wherein the ignition tip may be located at a position, which is distanced from the opening with a distance more than about one tenth of the length in the second direction.

Accordingly, an aspect of the present invention provides a fuel reforming system for generating reformed gas that mainly contains hydrogen from hydrogen containing fuel that mainly contains butane gas, in which a small-sized igniter is provided for effectively igniting combustion fuel including butane gas having a relatively high ignition point in a combustion chamber for supplying thermal energy, thereby minimizing the size of the fuel reforming system.

An aspect of the present invention provides a fuel reforming system, which may comprise: a burner or heater to burn combustion fuel that mainly contains butane gas; a reformer or fuel reforming reactor to receive heat energy from the burner and produce reformed gas that mainly contains hydrogen from reforming fuel that mainly contains butane gas; a CO remover connected to and communicating with the reformer and removing carbon monoxide from the reformed gas; and an igniter comprising an electrode inserted through an opening formed in the burner, wherein an insertion end of the electrode is bent toward an inner surface of the burner adjacent to the opening.

Another aspects of the present invention provides a fuel reforming system, which may comprise: a burner to burn combustion fuel that mainly contains butane gas; a reformer to receive heat energy from the burner and produce reformed gas that mainly contains hydrogen from reforming fuel that mainly contains butane gas; a CO remover connected to and communicating with the reformer and removing carbon monoxide from the reformed gas; and an igniter comprising a pair of wires spaced from each other at a first distance and inserted through the opening formed in the burner, and a power source to supply electricity to the wires, wherein insertion ends of the wires are spaced apart to be narrower than the first distance.

According to an aspect of the invention, the hydrogen containing fuel is supplied from a butane gas pressure container. Further, the CO remover comprises a shift reaction unit to reduce the concentration of carbon monoxide (CO) in the reformed gas by water shift reaction, and a CO oxidation unit to preferentially oxidize CO. Also, the reformer produces the reformed gas by a steam-reforming method, an auto-thermal reforming method or a preferential oxidation method.

### BRIEF DESCRIPTION OF THE DRAWINGS

These and other aspects and advantages of the invention will become apparent and more readily appreciated from the following description of the embodiments, taken in conjunction with the accompanying drawings of which:

FIG. 1 is a block diagram of a fuel cell system according to an embodiment of the present invention;

FIG. 2 illustrates an igniter mounted in a burner or heater of a fuel reforming system according to an embodiment of the present invention;

FIG. 3 is a sectional view of the burner for the fuel cell system in FIG. 2;

FIG. 4 is a partially enlarged sectional view of the burner for the fuel cell system according to an embodiment of the present invention;

FIG. 5 is a block diagram of an exemplary fuel cell system; and

FIG. 6 illustrates an exemplary reformer.

### DETAILED DESCRIPTION OF EMBODIMENTS

Hereinafter, various embodiments of the present invention will be described with reference to accompanying drawings.

In certain embodiments, fuel having a relatively high ignition point, e.g., hydrogen containing fuel that mainly contains butane is used, but not limited thereto. Some of the hydrogen containing fuel is employed as reforming fuel to be mixed with water and reformed, and the other some is employed as combustion fuel for supplying heat energy in order to heat a reforming reaction unit and a CO remover until they reach catalyst activation temperatures, respectively. Further, pure oxygen stored in a separate storage means or oxygen containing air can be employed as an oxidant. Hereinafter, oxygen contained in external air will be used as the oxidant.

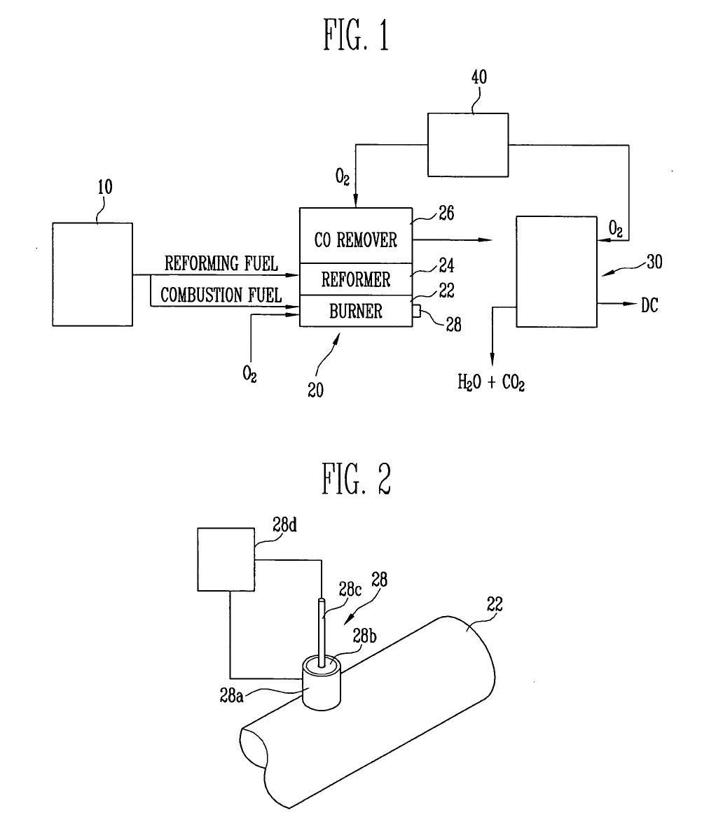

Referring to FIG. 1, a fuel cell system includes a fuel feeder 10 to supply fuel having a relatively high ignition point, e.g., hydrogen containing fuel that mainly contains butane; a reforming unit 20 to reform the hydrogen containing fuel from the fuel feeder 10 and produce hydrogen; and a stack 30 having an electric generator to generate electricity by electrochemical reaction between hydrogen from the reforming unit 20 and an oxidant. Here, a reference numeral of 40 indicates an air feeder to supply the oxidant such as air to a burner 22 and a preferential oxidation unit, which constitute the reforming unit 20 as well as the stack 30. The fuel feeder 10 can include a universal butane gas pressure container (not shown). Preferably, the fuel feeder 10 includes a vaporizer (not shown) to vaporize butane supplied from the butane gas pressure container. The vaporizer vaporizes butane by decreasing pressure or by heat energy from the burner (to be described later).

The reforming unit 20 includes a reformer 24 producing the reformed gas that mainly contains hydrogen from the reforming fuel supplied from the fuel feeder 10, and a CO remover 26 connected to communicate with the reformer 24 and removing carbon monoxide from the reformed gas. The reformer 24 is supplied with a reforming catalyst (not shown). The reformer 24 reforms the reforming fuel of the hydrogen contain fuel by a steam reforming (SR) method, an auto thermal reforming (ATR) method, a preferential oxidation (POX) method, etc., but not limited thereto. The preferential oxidation method and the auto thermal reforming method are good in characteristics responding to initial start and load variation, but the steam reforming method is good in efficiency of producing hydrogen.

The steam reforming method produces the reforming gas with the hydrogen base by a chemical reaction, i.e., an endothermic reaction between the hydrogen containing fuel and steam on a catalyst. Here, the steam reforming method has been most generally used because the reformed gas is stably supplied and relative high concentration of hydrogen is obtained even though it requires much energy to perform the endothermic reaction. Therefore, the steam reforming method has been widely used. For example, in the case where the reformer 24 employs the stream reforming method, a steam reforming reaction (refer to the following reaction formula 1) between the reforming fuel (i.e., the hydrogen containing fuel that mainly contains butane) supplied from the fuel feeder 10 and water occurs on the reforming catalyst, thereby producing the reformed gas with abundant hydrogen.
n−C₄H₁₀+8H₂O [symbol] 4CO₂+13H₂ΔH₂₉₈=485.3 KJ/mol [Reaction formula 1]

The reforming catalyst can include a carrier supported with metal such as ruthenium, rhodium, nickel, etc. The carrier can include zirconium dioxide, alumina, silica gel, active alumina, titanium dioxide, zeolite, active carbon, etc. The foregoing reformed gas slightly includes carbon dioxide, methane gas and carbon monoxide. Particularly, carbon monoxide poisons a platinum catalyst generally used for an electrode of the stack 30 and deteriorates the performance of the fuel cell system, so that it needs to remove carbon monoxide. To remove carbon monoxide, the CO remover 26 includes a water gas shift unit in which a water gas shift reaction is performed, and a preferential oxidation unit in which a preferential oxidation catalyst reaction is performed. The water gas shift unit is provided with a shift catalyst (not shown), and the preferential oxidation unit is provided with an oxidation catalyst (not shown). Further, an oxidant such as oxygen needed for a selective oxidizing reaction is supplied by the air feeder 40 to the preferential oxidation unit. The water gas shift reaction and the preferential oxidation catalyst reaction can be represented as the following reaction formulas 2 and 3, respectively.
CO+H₂O [symbol] CO₂+H₂ΔH₂₉₈=−41.1 KJ/mol [Reaction formula 2]
CO+1/2O₂ [symbol] CO₂ΔH₂₉₈=−284.1 KJ/mol [Reaction formula 3]

Meanwhile, the reforming unit 20 is provided with the burner or heater 22 using some of the hydrogen containing fuel, e.g., butane from the fuel feeder 10 as the combustion fuel. The burner 22 is supplied with the oxidant such as oxygen from the air feeder 40. Here, the burner 22 supplies heat energy needed for heating the reformer 24, the water gas shift unit and the preferential oxidation unit of the CO remover 26 provided in the reforming unit 20 to catalyst activation temperatures, respectively.

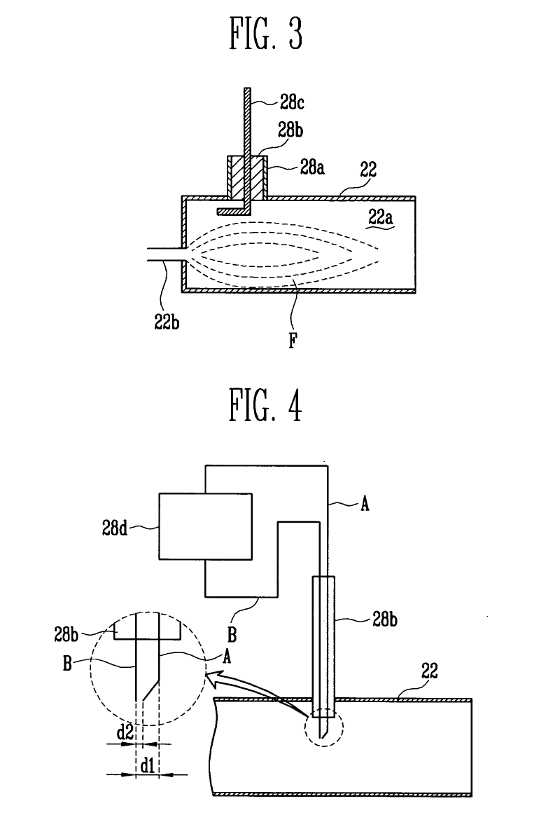

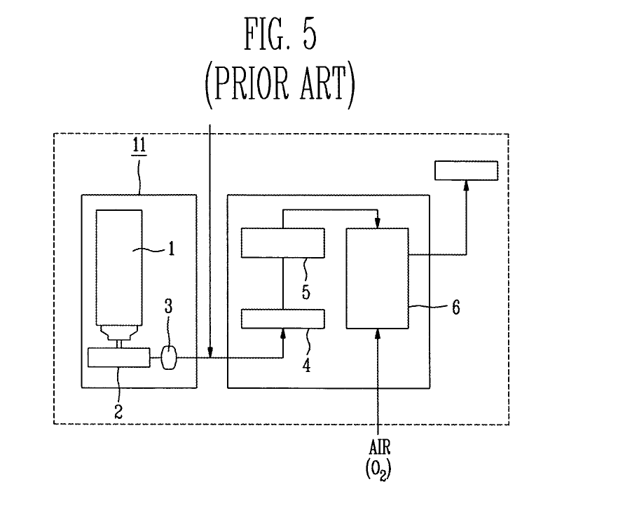

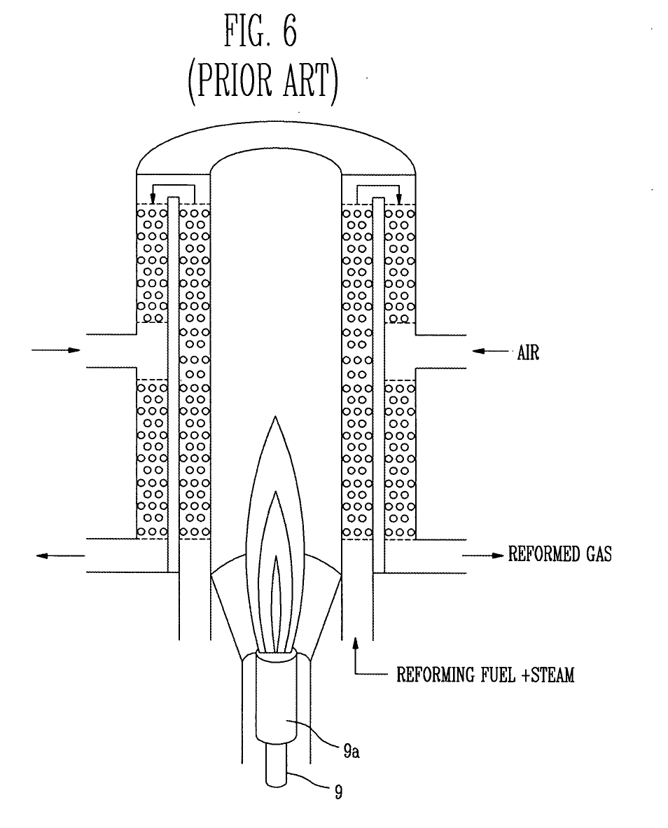

Referring to FIGS. 2 and 3, the burner 22 is provided with an igniter 28. The igniter 28 includes a tube 28a mounted in an opening (not shown) formed on one side of the burner 22, an insulator 28b filling the tube 28a, an electrode 28c penetrating the insulator 28b to the inside of the burner 22, and a power source 28d to supply electricity to the electrode 28c. For example, one wire extracted from the power source 28d is electrically connected to the electrode 28c, and the other wire is electrically connected to the tube 28a. At this time, the tube 28a and the outer surface of the burner 22 are formed as a single body. Further, an insertion end of the electrode 28c penetrating the insulator 28b and exposed to the inside of the burner 22 is bent to be close to the inner surface of the burner 22 adjacent to the opening. Thus, the electrode 28c is protected from high temperature in the burner 22, thereby improving the durability of the electrode 28c.

Inside the burner 22, the insertion end of the electrode 28c is spaced apart from the inner surface of the burner 22 adjacent to the opening at a predetermined distance. For example, the distance ranges from about 0.7 mm to about 1 mm. Therefore, when electricity is supplied from the power source 28d to the electrode 28c, electric discharge between the insertion end of the electrode 28c and the inner surface of the burner 22 can generate a spark. In one embodiment, the electrode 28c is made of a heat resistance material to resist high temperature due to the spark or flame F. The combustion fuel introduced into the burner 22 at an initial operation of the fuel reforming system is burned by the electric spark occurring when the electricity is supplied to the electrode 28c of the igniter 28. Then, while the fuel reforming system is operating, the combustion fuel continuously introduced into the burner 22 is naturally burned without operating the igniter 28.

While the combustion fuel is being burned, flames F can reach and heat the igniter 28 to very high temperature, which may negatively affect the durability of the igniter 28. Thus, as shown in FIG. 3, the igniter 28 may be installed afar off the introduction portion of the combustion fuel in the heater or burner. Especially, the insertion end of the electrode 28c may be positioned apart from the flames F.

In certain embodiments, the burner or heater 22 has a chamber 22a and a nozzle 22b. The nozzle 22b has an opening formed into the chamber 22a. The igniter 28 has an ignition tip located in the chamber 22a. In the illustrated embodiment and certain other embodiments, the ignition tip is installed at a location where the temperature there is substantially different from the temperature near the opening of the nozzle, optionally substantially throughout during oxidizing or burning the fuel. In one embodiment, the difference between the temperature at the ignition tip and the temperature near the opening is greater than about 10 to 200° C. In some embodiments, the difference between the temperature at the ignition tip and the temperature near the opening is greater than about 10, 20, 30, 40, 50, 60, 70, 80, 90, 100, 120, 150 or 200° C. In some of the above embodiments and other embodiments, the temperature at the opening is greater than the temperature at the ignition tip.

In certain embodiments, the ignition tip is installed at a position, which is distanced from the opening of the nozzle 22b in various directions. In some embodiment, the ignition tip is distanced from the opening in a first direction where the fuel is generally injected into the chamber 22a. In other embodiments, the ignition tip is distanced from the opening in a second direction perpendicular to the first direction. In some embodiments, the ignition tip is distanced from the opening in both the first and second directions. In embodiments where the length of the chamber 22a in the first direction is referred to as a first length, the ratio of the first distance to the first length is about 0.05, 0.1, 0.2, 0.3, 0.4, 0.5, 0.6, 0.7, 0.8, 0.9 or 1.0. In some embodiments, the ratio may be within a range defined by two of the foregoing ratios. In embodiments where the length of the chamber in the second direction is referred to as a second length, the ratio of the second distance to the second length is about 0.05, 0.1, 0.2, 0.3, 0.4, 0.5, 0.6, 0.7, 0.8, 0.9 or 1.0. In some embodiment, the ratio of the second distance to the second length may be within a range defined by two of the foregoing ratios.

In some embodiments, ignition tip is shielded from direct reach of the flames. In certain embodiments, a shielding wall or partition is placed generally between the nozzle opening and ignition tip. The shielding wall or partition is configured to efficiently inhibit the flames from reaching the ignition tip. In other embodiments, the chamber contains certain materials or structures near or around the ignition tip, wherein such materials or structures are configured to less heat conductive than other materials contained in the chamber.

Meanwhile, as shown in FIG. 4, instead of using the electrode, the igniter 28 can be achieved by wires A and B extracted from the power source 28d and exposed to the inside of the burner 22, thereby performing the combustion for the combustion fuel. In this case, the insulator 28b fills in the opening of the burner 22, and the wires A and B penetrate the insulator 28b and are exposed to the inside of the burner 22 while being spaced apart from each other at a distance d1. At this time, at least one end of the wires A and B exposed to the inside of the burner 22 is bent to be close to the other end at a distance d2. Thus, when the electricity is supplied from the power source 28d to the wires A and B, the electric spark occurs due to the electric charge between the ends of the wires.

As described above, the combustion reaction of the combustion fuel due to the electric spark occurring between the electrode and the inner surface of the burner or between the ends of the adjacent wires can be represented as follows.
n−C₄H₁₀+6.5O₂→4CO₂+5H₂OΔH₂₉₈=−2658.5 KJ/mol [Reaction formula 4]

Below, operations of the fuel cell system with the fuel reforming system according to an embodiment of the present invention will be described. First, at the initial operation of the fuel cell system, some of butane gas supplied from the fuel feeder 10, e.g., the butane gas pressure container is introduced as the combustion fuel to the burner 22, and the other some of butane gas is introduced as the reforming fuel to the reformer 24. At this time, the reforming fuel can be supplied to the reformer 24 via the vaporizer (not shown). Further, the burner 22 is fed with oxygen from the air feeder 40, and the reformer 24 is fed with water.

Some of the butane gas supplied to the burner 22 (i.e., the combustion fuel) is burned by ignition of the igniter 28 (i.e., the electric spark occurring between the electrode and the inner surface of the burner 22 or between the ends of the adjacent wires) on the basis of the combustion reaction of the reaction formula 4. Then, the heat energy generated at this time is transferred to the reformer 24 and the CO remover 26. Particularly, in the state that the water gas shift unit is heated to have the activation temperature for a shift catalyst (e.g., copper-zinc catalyst), and the reformer 24 and the CO remover 26 are heated by the heat energy transferred from the burner 22 to have the respective catalyst activation temperature, the butane gas supplied from the fuel feeder 10 (i.e., the reforming fuel) is changed into the reformed gas, which mainly contains hydrogen, by the reaction based on the reaction formula 1 while passing through the reformer 24.

Further, while the reformed gas passes through the CO remover 26, carbon monoxide is removed from the reformed gas. In more detail, carbon monoxide is primarily removed from the reformed gas by the reaction based on the reaction formula 2 while the reformed gas passes through the CO remover 26, so that the content of carbon monoxide in the reformed gas is primarily reduced. Then, the reformed gas, of which carbon monoxide is primarily reduced, passes through the preferential oxidation unit connected to and communicating with a rear end of the water gas shift unit, so that carbon monoxide remained in the reformed gas is secondarily removed by the redaction based on the reaction formula 3, thereby producing hydrogen with approximately high purity.

Such high purity hydrogen is supplied to the electric generator of the stack 30. When hydrogen with high purity and air are supplied to the anode electrode and the cathode electrode of the stack 30, respectively, the electricity generated by the oxidation reaction of hydrogen is supplied to an external circuit through a collector (not shown) In more detail, the high purity hydrogen produced from the preferential oxidation unit 26 of the reforming unit 20 is supplied to the anode electrode (not shown) of the stack 30, and oxygen containing air is supplied from the air feeder 40 to the cathode electrode (not shown) of the stack 30. Further, as hydrogen ions are transferred via the MEA (not shown) of the stack 30, the electricity is generated by a chemical reaction between hydrogen and oxygen. Also, water produced based on the chemical reaction in the stack 30 is recovered and the recycled.

According to an embodiment of the present invention, the size of the igniter for effectively burning the combustion fuel such as butane gas in the burner for supplying heat energy is minimized, thereby providing the fuel reforming system having a small size.

Although various embodiments of the present invention have been shown and described, it would be appreciated by those skilled in the art that changes might be made in this embodiment without departing from the principles and spirit of the invention, the scope of which is defined in the claims and their equivalents.

What is claimed is:

1. A method of heating a fuel reforming reactor for use with a fuel cell, the method comprising:
providing a heater comprising a chamber, a nozzle and an igniter, wherein the nozzle comprises an opening formed into the chamber, wherein the igniter comprises an ignition tip located in the chamber;
supplying a fuel into the chamber through the opening of the nozzle;
igniting the fuel within the chamber using the ignition tip;
oxidizing the fuel and thereby generating heat within the chamber; and
supplying the heat to a fuel reforming reactor;
wherein the temperature at the ignition tip is substantially different from the temperature near the opening of the nozzle substantially throughout during oxidizing the fuel.

2. The method of claim 1, wherein the temperature of the ignition tip is different from temperature near the opening of the nozzle by at least 10 to 200° C.

3. The method of claim 1, wherein the temperature of the ignition tip is different from temperature near the opening of the nozzle by at least 50 to 100° C.

4. The method of claim 1, wherein the temperature of the ignition tip is substantially lower than the temperature near the opening of the nozzle.

5. The method of claim 1, wherein the temperature of the ignition tip is substantially lower than the temperature at the opening of the nozzle by at least 10 to 200° C.

6.

7. The method of claim 1, wherein the nozzle is configured to inject fuel into the chamber in a direction, wherein the chamber has a length in the direction, and wherein the ignition tip is located at a position, which is distanced from the opening with a distance more than about one tenth of the length in the direction.

8. The method of claim 1, wherein the nozzle is configured to inject fuel into the chamber in a first direction, wherein the chamber has a length in a second direction perpendicular to the first direction, and wherein the ignition tip is located at a position, which is distanced from the opening with a distance more than about one tenth of the length in the second direction.

9. The method of claim 1, wherein the ignition tip is located in an area where the temperature thereof does not reach 1000° C.

10. The method of claim 1, wherein the ignition tip comprises a carbon electrode, and wherein the fuel comprises butane.

11. The method of claim 1, wherein the fuel comprises at least one compound selected from the group consisting of methane, ethane, propane, butane, pentane, hexane, heptane, octane, ethylene, propylene, butylene, and acetylene.

12. The method of claim 1, wherein the heater further comprises a wall substantially creating a temperature barrier between the opening and the ignition tip.

13. The method of claim 1, wherein igniting creates a flame within the chamber, wherein the flame does not contact the ignition tip.

14. The method of claim 1, wherein the heater further comprises an oxidation catalyst in the chamber.

15. An apparatus for use in heating a fuel reforming reactor of a fuel cell, the apparatus comprising:
an oxidation chamber;
a nozzle configured to supply fuel into the oxidation chamber, the nozzle comprising an opening formed into the chamber; and
an igniter comprising an ignition tip configured to ignite fuel within the chamber, wherein the ignition tip is distanced from the opening such that wherein the temperature at the ignition tip is substantially different from the temperature at the opening of the nozzle substantially throughout during oxidizing the fuel.

16.

17. The apparatus of claim 15, wherein the nozzle is configured to inject fuel into the chamber in a direction, wherein the chamber has a length in the direction, and wherein the ignition tip is located at a position, which is distanced from the opening with a distance more than about one tenth of the length in the direction.

18. The apparatus of claim 15, wherein the nozzle is configured to inject fuel into the chamber in a first direction, wherein the chamber has a length in a second direction perpendicular to the first direction, and wherein the ignition tip is located at a position, which is distanced from the opening with a distance more than about one tenth of the length in the second direction.
